(19) United States
(12) Patent Application Publication
(10) Pub. No.: US 2021/0191413 A1
(43) Pub. Date: Jun. 24, 2021

(54) Machine Sunk Detection System and Method

(71) Applicant: Caterpillar Paving Products Inc., Brooklyn Park, MN (US)

(72) Inventor: Timothy M. O'Donnell, Germantown Hills, IL (US)

(73) Assignee: Caterpillar Paving Products Inc., Brooklyn Park, MN (US)

(21) Appl. No.: 16/719,285

(22) Filed: Dec. 18, 2019

(51) Int. Cl. G05D 1/02; G05D 1/00; B60W 40/06; E01C 23/07

(52) U.S. Cl. CPC G05D 1/0227; G05D 1/0231; G05D 1/0088; B60W 40/06; B60W 2420/42; G05D 2201/0202; B60W 2420/52; B60W 2550/147; E01C 23/07

(57) ABSTRACT

A machine includes a frame, a plurality of ground engaging members associated with the frame, the plurality of ground engaging members configured to move the machine along a ground surface, a ground sensor attached to the frame, the ground sensor providing ground surface information, and an electronic controller associated with the frame. The electronic controller is programmed and configured to receive the ground surface information from the ground sensor, estimate a location of the ground surface relative to the frame of the machine, establish a height difference between the location of the ground surface and the frame of the machine, monitor the height difference continuously during operation of the machine, and provide a sunk condition indication when the height difference reduces below an acceptable threshold.

### TECHNICAL FIELD

The present disclosure relates generally to machines for the treatment of road surfaces and, more particularly, to a cold planner or milling machine for roadway surfacing or resurfacing operations.

### BACKGROUND

Autonomous machines are machines configured to operate without continuous intervention by a human operator. Such machines may operate on paved or unpaved surfaces, as a particular application may require, and can often operate in less than ideal ground support conditions. For example, operation in an open field presents the possibility that a machine may traverse a muddy area. Due to the large weight of the machine, traversing a muddy area or patch may cause the machine to become stuck as the machine's wheels or other ground engaging members sink and become stuck in the mud. Currently, operators try to identify problematic areas in a field and instruct the machine software to avoid those areas. However, identification of problem areas may not always be possible or complete, and as a result autonomous machines may still become stuck, which can adversely affect the machines' uptime and efficiency.

Detection of surroundings for purpose of control of an autonomous vehicle has been proposed in the past. For example, US 2019/0079539 A1 describes systems and methods for determining a location of a vehicle. In this reference, a method for localizing the vehicle includes driving over a first road segment while obtaining vertical motion data. This data is them compared to reference vertical motion data to identify the location of the vehicle. While the method described in this reference may help determine a location of the vehicle, it presupposes that reference vertical motion data for a road segment is known, and also requires travel of the vehicle along that road segment. The systems and methods described are, therefore, not applicable for off-road vehicles travelling over unknown terrain.

### SUMMARY

The disclosure describes, in one aspect, a machine. A machine includes a frame, a plurality of ground engaging members associated with the frame, the plurality of ground engaging members configured to move the machine along a ground surface, a ground sensor attached to the frame, the ground sensor providing ground surface information, and an electronic controller associated with the frame. The electronic controller is programmed and configured to receive the ground surface information from the ground sensor, estimate a location of the ground surface relative to the frame of the machine, establish a height difference between the location of the ground surface and the frame of the machine, monitor the height difference continuously during operation of the machine, and provide a sunk condition indication when the height difference reduces below an acceptable threshold.

In another aspect, the disclosure describes a machine. The machine includes a frame, a plurality of ground engaging members associated with the frame, the plurality of ground engaging members configured to move the machine along a ground surface, a work implement associated with the frame, the work implement operating to change a shape of the ground surface it traverses during operation, a plurality of ground sensors attached to the machine, the plurality of ground sensors providing ground surface and compacted ground surface information, and an electronic controller associated with the frame.

The electronic controller is programmed and configured to receive the ground surface and compacted ground surface information from the plurality of ground sensors, estimate a location of the ground surface and the compacted ground surface relative to the frame of the machine, establish a first height difference between the location of the ground surface and the frame of the machine, establish a second height difference between the location of the compacted ground surface and the frame of the machine, monitor the first and second height differences continuously during operation of the machine, provide a sunk condition indication when the first height difference reduces below a first acceptable threshold, and provide a ground condition alert when the second height difference reduces below a second acceptable threshold.

In yet another aspect, the disclosure describes a method for operating an autonomous machine. The method includes operating the machine to autonomously traverse an area, operating one or more sensors associated with the machine to acquire data indicative of a contour of a surface located below a frame of the machine, providing the acquired data to a controller, using the controller to create a presumed ground surface based on the acquired data, using the controller to establish a height difference between the presumed ground surface and the frame of the machine, monitoring the height difference continuously while the machine traverses the area, and providing a sunk condition indication in the controller when the height difference is determined to reduce below a threshold value.

### BRIEF DESCRIPTION OF THE DRAWINGS

FIG. 1 is an outline view from a side perspective of a machine in accordance with the disclosure.

FIG. 2 is an outline view from a side perspective of the machine of FIG. 1 during an operating condition.

FIG. 3 is an outline view from a side perspective of an alternative embodiment of a machine in accordance with the disclosure.

FIG. 4 is a flowchart for a method in accordance with the disclosure.

### DETAILED DESCRIPTION

The present disclosure relates to a system and method for detecting undesired sinking of a machine into the ground, especially an autonomous machine that does not have a human operator directly controlling its motion and operation from within an operator cab of the machine. The disclosure contemplates at embodiment in which sensors associated with an autonomous machine are used to measure a distance from a point on the machine frame to the ground surface. These measurements may be sent to a controller of the machine that monitors readings as the machine traverses the terrain.

When the controller determines based on sensor inputs that a distance from the frame to the ground decreases past a predetermined threshold, the controller may recognize a sinking condition and either stop the machine or alter operation of the machine based on the ground conditions. Altering operation of the machine may include downshifting, reducing speed, limiting turning radius and others. The location of the poor ground conditions may be determined using global positioning system (GPS) or global navigation satellite system (GNSS) sensors on the machine and may be documented either in a fleet management system or reported to a site manager. Further, to avoid false-positive determinations, more than one sensor may be used to provide an overall distance of multiple points on the machine frame to the ground such that isolated obstacles, for example, piles of dirt, stumps, etc. do not provide misleading readings to a single sensor. Instead, a baseline ground surface of the area surrounding the machine may be continuously determined and updated in real time, and then compared to the clearance height of the machine frame, or another portion of the machine, to the baseline ground surface. The sensors used to detect the distance of a portion of the machine to the ground may be configured to detect the ground surface and also the surface of water, in the event the unfavorable condition includes sinking of the machine into a deep, water filled, area.

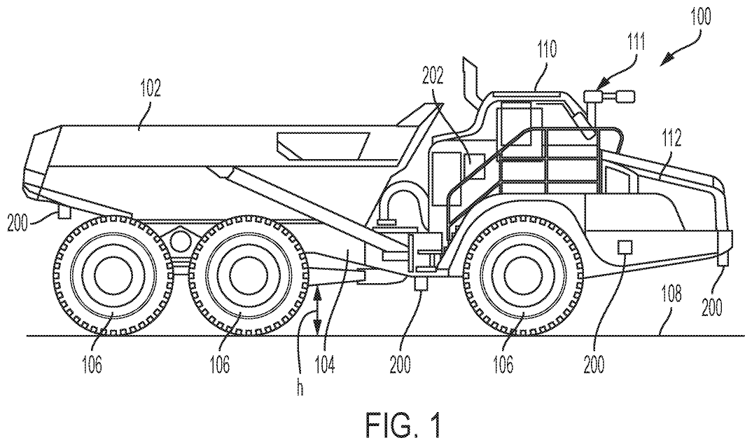

FIG. 1 illustrates a machine 100, which is embodied as an off-highway truck, in accordance with the disclosure. The machine 100 includes a work implement 102, embodied as a truck bed, which is pivotally connected to a frame 104. During typical operation, the machine 100 travels between a loading location, where material is loaded into the work implement 102, in this case, the bed, to a dumping location, where the material is off-loaded from the bed, and then returns to the loading location to repeat the process. In the typical configuration illustrated in FIG. 1, the machine 100 includes ground-engaging members or wheels 106 that allow the frame 104 to travel along a ground surface 108. The machine 100 further includes an operator cab 110 and an engine 112.

In the illustrated embodiment, the machine 100 is autonomously guided, meaning, there is no human operator that occupies the cab 110 during operation. Instead, emitters and receivers of information 111 are used to communicate with a control center (not shown) that provides commands to the machine 100 during operation. The machine 100 includes a controller 202 that receives instructions from the control center and effects or carries out various operations autonomously, including driving the machine 100 between the loading and dumping locations.

While various sensors on the machine 100 communicate with the controller 202 and provide signals and other information to facilitate the autonomous operation of the machine 100, this function is not the focus of the present disclosure and is considered generally and generically known by those skilled in the art. Instead, the present disclosure describes the sensors, systems and methods for determining ground quality during machine operation and especially during travel of the machine over terrain whose condition is unknown at the time of travel of the machine over the terrain. For example, the machine may travel over terrain on which the machine, or another similar machine, has not travelled over before and thus the condition of the ground is unknown. In addition, even if the machine has traversed a terrain before, the passage of time or environmental factors such as rain, erosion and the like may have changed the character of the terrain in general or, more specifically, in the ability of the terrain to support the weight of the machine.

To enable a determination of the quality of the terrain, and specifically regarding the ability of the terrain to support the weight of the machine as it traverses the terrain, the machine 100 includes one or more sensors 200. Each sensor 200 may be embodied as a three-dimensional (3D) sensor such as a LiDAR (light detection and ranging) sensor, stereographic camera, and the like, which is configured and operates to acquire three-dimensional data of an area into which the sensor is pointed. For example, the sensor may sense ambient or emitted light radiation that reflects off surrounding ground surface 108, and provide to the controller 202 signals indicative of the sensor readings, which can include contour maps or the three dimensional location of one or more points on the ground relative to the location of the sensor 200 on the machine 100. The controller 202 may then calculate, interpolate or otherwise determine a location or position of the machine, for example, the frame 104, relative to the ground surface 108 based on the known relation or position of the sensor 200 on the machine frame 104.

To avoid any false-positive determinations, for example, if the machine traverses a dip or a boulder or other positive or protruding ground feature directly in front of a sensor 200, the machine may include a plurality of sensors 200 disposed at different locations around the machine 100. In the illustrated embodiment, the machine 100 includes sensors 200 disposed at the front and rear of the machine, on the right and left sides (only the right side is visible), and also beneath the bottom of the frame, closest to the ground. In this way, all sides of the machine, including the frame itself, can be monitored for clearance to the ground surface 108.

The sensors 200 are communicatively associated or connected with the controller 202, and provide signals to the controller 202 that are indicative of the ground surfaced attributes perceived by the sensors 200. The controller 202, along with additional signals such as global positioning signals (GPS), inclination signals, altitude signals, and the like, may stitch together a three dimensional representation of the ground surface on which the machine is travelling. The stitched together ground surface may extend only immediately below and/or in a close proximity around the machine 100, or may alternatively also encompass ground surfaces that are further away from the machine, in a single direction such as the front or in multiple directions around the machine, encompassing distances of tens of meters.

When the information has been compiled, the controller 202 may continuously interrogate or monitor signals from the sensors 202 to determine whether the wheels or ground engaging members 106 of the machine are riding within an acceptable depth tolerance of the measured and monitored ground surface. For example, traversing a soft ground material such as sand may cause an increased but still acceptable depth of machine tracks. Similarly, a rough terrain such as a gravel substrate may provide a less accurate measurement of the location of the ground surface to the controller 202 that a flat, hard ground surface may.

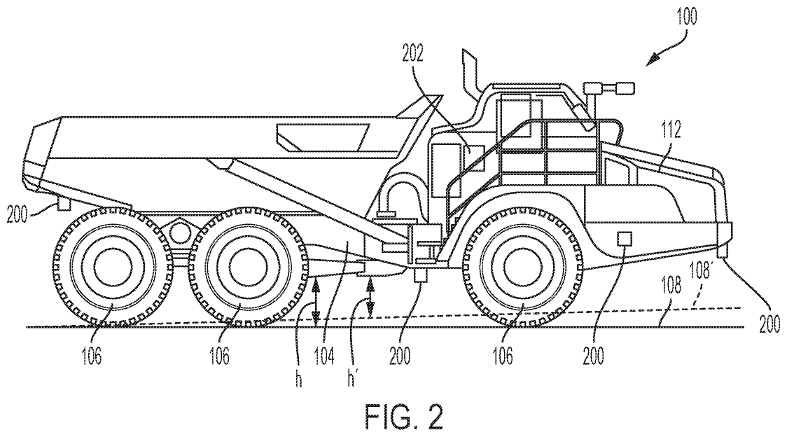

Relevant to the present disclosure, the controller 202 will determine a sinking condition of the machine when the difference between a ride height of the machine or, stated differently, a height, h, as shown in FIG. 1, between the machine frame 104 and the ground 108 reduces at least locally to less than acceptable threshold value. A simulation of such an operating condition is shown in FIG. 2, where the machine 100 rides on a surface 108 that is below an expected surface 108′ that was previously sensed and determined by the controller 202. More specifically, before the machine 100 traversed the location shown in FIG. 2, the controller 202, based on the signals from sensors 200, determined that the surface of the ground should be at the level 108′. That level could have been presented by a soft material, such as mud or water, that provided the illusion of a ground surface to the sensors 200 and, thus, caused the controller 202 to make a false determination. As the machine traversed the area, the weight of the machine causes the wheels 106 to maintain contact with the hard under-surface 108, causing the machine to sink into the surface 108′.

As the machine 100 sinks from the surface 108′ to the surface 108, the distance h between the frame 104 to the ground surface under normal ground conditions reduces (due to machine sinking) to a distance h′ that is less than the distance h. The controller 202 monitoring the distance between the machine frame 104 to the ground, which determination can be made relative to one or more locations around the machine 100, can compare the height h with a desired or predetermined distance such that, when the height h′ differs from the height h by more than a predetermined threshold, the controller 202 may first determine whether the machine is in a special work mode and, if not, deduce that a sinking condition is present.

When a sinking condition is present or, in other words, when the controller detects a sunk condition of the machine, various mitigation measures may be automatically implemented. For example, the machine may stop and reverse, until the sunk condition is no longer present and the machine is on solid ground. In addition, or alternatively, the controller may otherwise alter operation of the machine such as cause the machine to downshift, such that additional torque is provided to the wheels to overcome the effects of unstable ground, reduce machine speed so the machine can wade through a deep puddle, limit turn radius of the machine, so a more shallow turn can be made, and others. Additionally, the controller may include geographical location information of the present location of the machine, for example, using input from geolocation or site location data from sensors, and mark an area in which a sinking condition was detected for future reference and/or for the benefit of other machines that may be operating in the area.

The sunk condition detection may be carried out using more than one severity. For example, based on the comparison of the heights h and h′, the machine may continue moving through an area with an altered operation for shallow sinking conditions, and may stop and reverse for more extreme sinking conditions. The thresholds used to distinguish shallow from severe sinking may depend on the type of machine, the size of the wheels, the loading condition or weight of the machine, and other parameters.

It should be noted that the controller 202 described herein, and its functionality, can be implemented in hardware or software. In general, the electronic controller may be a single controller or may include more than one controller disposed to control various functions and/or features of a machine. For example, a master controller, used to control the overall operation and function of the machine, may be cooperatively implemented with a motor or engine controller, used to control various parts and systems of the machine such as the engine, transmission and the like. In this embodiment, the term “controller” is meant to include one, two, or more controllers that may be associated with the machine 100 and that may cooperate in controlling various functions and operations of the machine 100 (FIG. 1). The functionality of the controller, while described conceptually herein to include various discrete functions for illustrative purposes only, may be implemented in hardware and/or software without regard to the discrete functionality described. Accordingly, various interfaces of the controller are described relative to components of the machine 100, but such interfaces are not intended to limit the type and number of components that are connected, nor the number of controllers that are described.

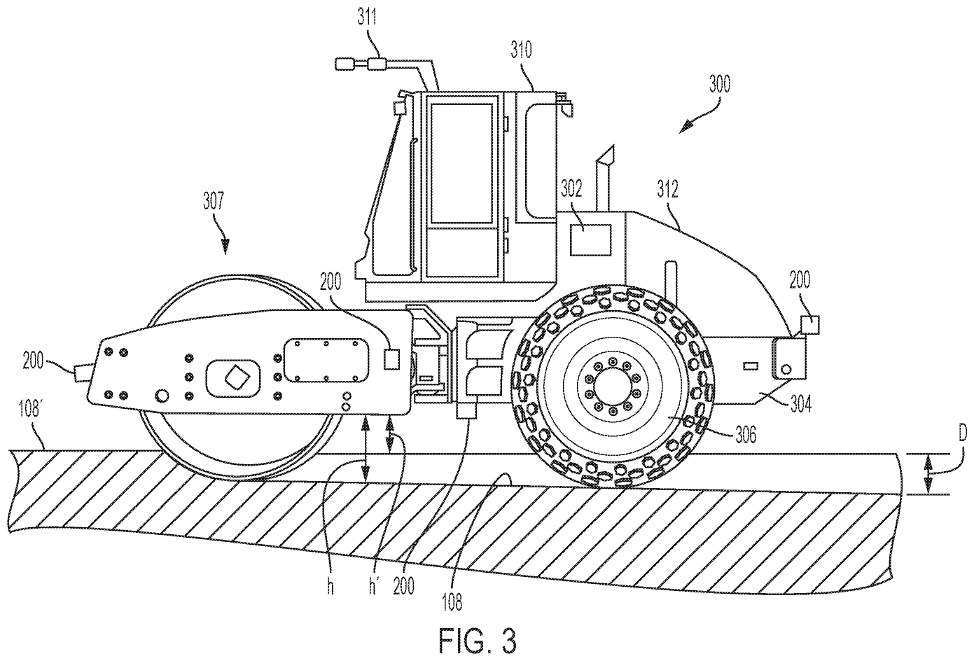

An alternative embodiment for a machine 300 is shown in FIG. 3. In this embodiment, elements and features of the machine 300 or its operation that are the same or similar to corresponding elements and features of the machine 100 (FIGS. 1 and 2) are denoted by the same reference numerals as previously used for simplicity. It is important to note that, while the machine 100 is a truck that is expected to run on the ground surface 108 and monitor for the presence of a sunk condition, the machine 300 is a compactor that compacts its work surface such that the surface of operation of the machine 108 becomes compacted and vertically displaces relative to a surrounding ground surface 108′ by a compaction depth, D, as shown in FIG. 3.

The machine 300 is embodied as a soil compactor. Similar to the machine 100, the machine 300 includes a work implement 307, which is embodied as a compaction drum. During typical operation, the machine 300 travels along a surface to compact the surface. The machine 300 may perform consecutive runs in a snake or other pattern to compact an entire work field, and may further traverse the same area more than once to achieve a desired compaction. In the typical configuration illustrated in FIG. 3, the machine 300 includes ground-engaging members or wheels 306 that allow the frame 304 to travel along the ground surface 108. The machine 100 further includes an operator cab 310 and an engine 312.

In the illustrated embodiment, the machine 300 is autonomously guided, meaning, there is no human operator that occupies the cab 310 during operation. Instead, emitters and receivers of information 311 are used to communicate with a control center (not shown) that provides commands to the machine 300 during operation. The machine 100 includes a controller 302 that receives instructions from the control center and effects or carries out various operations autonomously, including driving the machine 300 along its compaction path.

While various sensors on the machine 300 communicate with the controller 302 and provide signals and other information to facilitate the autonomous operation of the machine 300, this function is not the focus of the present disclosure and is considered generally and generically known by those skilled in the art. Instead, the present disclosure describes the sensors, systems and methods for determining ground quality during machine operation and especially during travel of the machine over terrain whose condition is unknown at the time of travel of the machine over the terrain. For example, the machine may travel over terrain on which the machine, or another similar machine, has not travelled over before and thus the condition of the ground is unknown. In addition, even if the machine has traversed a terrain before, the passage of time or environmental factors such as rain, erosion and the like may have changed the character of the terrain in general or, more specifically, in the ability of the terrain to support the weight of the machine and to be compacted to an expected depth, which is neither larger nor smaller than the expected compaction depth, D. The expected compaction characteristics of the ground surface 108′ can be predetermined or determined after a preselected time during operation of the machine. For example, if the average compaction depth D is determined for a particular field to be a particular value, X, +/−dX, during a calibration period, for example, a distance of 100 m travelled, steady travel above a minimum ground speed for a period such as 5 minutes, or another metric that indicates steady operation, then a compaction that falls outside of the expected range may signify suboptimal ground conditions.

In the machine 300, like the machine 100, the sensors 200 are distributed around and below the machine and are embodied as three-dimensional (3D) sensors such as a LiDAR (light detection and ranging) sensor, stereographic camera, and the like, which are configured and operate to acquire three-dimensional data of area towards which the sensors are pointed. The controller 302 may calculates, interpolates or otherwise determines a location or position of the machine, for example, the frame 304, relative to the ground surface 108 based on the known relation or position of the sensor 200 on the machine frame 104, and also the position of the frame relative to the surface 108′. In other words, the controller 302 may continuously monitor the compaction depth D to determine whether ground conditions change during machine operation. This operation is useful both for determining a sinking condition as well as determining the quality of machine operation over portions of a work area or field.

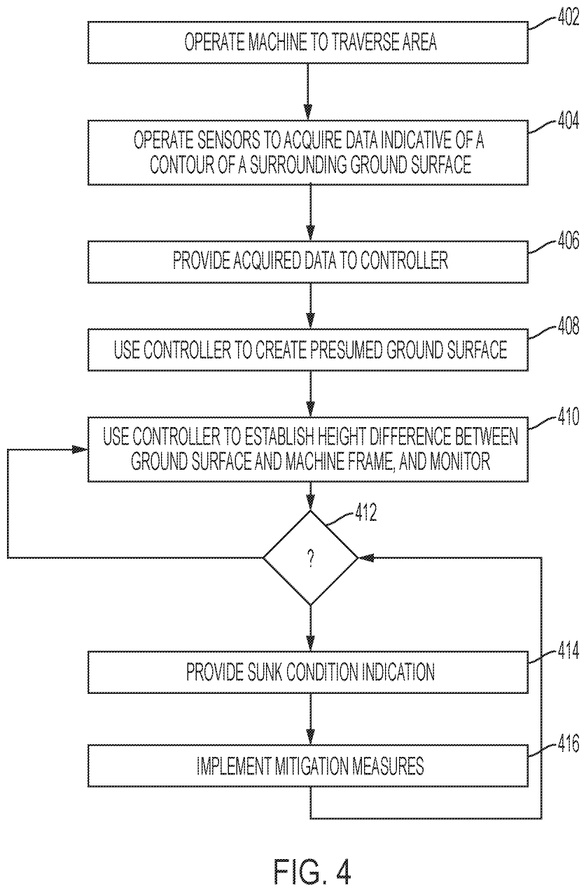

A flowchart for a method of operating an autonomous machine is shown in FIG. 4. In accordance with the method, the machine operates to traverse an area at 402. Such operation may be carried out autonomously, meaning, no operator may be physically present in the machine or operate its controls locally at the machine. While the machine traverses an area, one or more sensors may operate to acquire data indicative of a contour of a surrounding ground surface around the area onto which the machine has travelled, is currently traversing, and/or will traverse at 404. The data acquired by the sensors, which may be embodied as 3D sensors such as LiDAR, stereographic cameras, sonic sensors, and the like, is provided to controller at 406, which controller stitches together an estimated shape of the ground surface at 408 to create a presumed ground surface. The presumed ground surface, which may be flat or contoured and which may be limited to an area immediately below a frame of the machine, or alternatively extend further out from the machine in one or in multiple directions, establishes a height difference between the machine frame and a surface of the ground at 410, within the controller.

The controller may continuously monitor the height difference while the machine operates to determine when the height difference established changes beyond an acceptable threshold at 412. While the machine rides along the area at an acceptable ground clearance between the ground surface and the frame of the machine, the controller continues to monitor and the process repeats at 410. At time during operation when the height difference between the frame of the machine and the ground surface reduces beyond an acceptable limit, which is understood by the controller to indicate that the wheels or other ground engaging members of the machine may be sinking into the ground surface, then the controller provides a sunk condition indication at 414, and may implement mitigation measures at 416.

Examples of mitigation measures include downshifting of the machine and/or reducing speed of the machine, to provide additional torque to the wheels or other ground engaging members, limiting turning radius of the machine, to avoid digging into the ground with the wheels, and others. The controller may further mark the area and transmit this information to a central control such that the area may be avoided in subsequent passes and/or to warn other machines working in the same area about the different ground conditions encountered by this machine. The location of the poor ground conditions may be determined using GPS or GNSS sensors on the machine and may be further documented either in a fleet management system or reported to a site manager.

### INDUSTRIAL APPLICABILITY

This disclosure relates to surface working machines such as cold planers, soil recyclers, scrapers, compactors, graders, tillers and the like. The exemplary machine embodiments illustrated and described herein may travel on a ground surface or may alter the ground surface as part of their operation. While these exemplary embodiments illustrate the various aspects of the disclosure, it should be appreciated that any other machine type or configuration, which includes a ground-penetrating tool that penetrates the surface on which the machine is disposed, and covers a work area while the machine travels along the surface, to produce a strip of worked-surface, is applicable to, and can benefit from, the various systems and methods described herein.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A machine, comprising:
a frame;
a plurality of ground engaging members associated with the frame, the plurality of ground engaging members configured to move the machine along a ground surface;
a ground sensor attached to the frame, the ground sensor providing ground surface information; and
an electronic controller associated with the frame, the electronic controller being programmed and configured to:
receive the ground surface information from the ground sensor;
estimate a location of the ground surface relative to the frame of the machine;
establish a height difference between the location of the ground surface and the frame of the machine;
monitor the height difference continuously during operation of the machine; and
provide a sunk condition indication when the height difference reduces below an acceptable threshold.

2. The machine of claim 1, further comprising a plurality of ground sensors, wherein the ground sensor is one of the plurality of ground sensors, the plurality of ground sensors disposed on the machine, wherein each of the plurality of ground sensors provides a respective ground signal containing the ground surface information to the electronic controller.

3. The machine of claim 2, wherein the electronic controller is further configured to compile a surface contour for an area extending below and around the machine based on the ground surface information provided to the electronic controller by the plurality of ground sensors.

4. The machine of claim 1, wherein the ground sensor is a three-dimensional sensor.

5. The machine of claim 4, wherein the ground sensor is one of a LiDAR (light detection and ranging) sensor, and a stereographic camera.

6. The machine of claim 1, wherein following provision of the sunk condition indication, the electronic controller is further configured to adjust a control parameter of the machine.

7. The machine of claim 6, wherein adjusting a control parameter of the machine in the presence of the sunk condition indication includes at least one of:
commanding a downshift of the machine;
reducing a speed of the machine, and
limiting a turning radius of the machine.

8. A machine, comprising:
a frame;
a plurality of ground engaging members associated with the frame, the plurality of ground engaging members configured to move the machine along a ground surface;
a work implement associated with the frame, the work implement operating to change a shape of the ground surface to a compacted ground surface during operation;
a plurality of ground sensors attached to the machine, the plurality of ground sensors providing ground surface and compacted ground surface information; and
an electronic controller associated with the frame, the electronic controller being programmed and configured to:
receive the ground surface and compacted ground surface information from the plurality of ground sensors;
estimate a location of the ground surface and the compacted ground surface relative to the frame of the machine;
establish a first height difference between the location of the ground surface and the frame of the machine;
establish a second height difference between the location of the compacted ground surface and the frame of the machine;
monitor the first and second height differences continuously during operation of the machine; and
provide a sunk condition indication when the first height difference reduces below a first acceptable threshold; and
provide a ground condition alert when the second height difference reduces below a second acceptable threshold.

9. The machine of claim 1, wherein one of the plurality of ground sensors is disposed on the frame for measuring the compacted ground surface below the frame, and wherein another one of the plurality of ground sensors is disposed on a side of the machine for measuring the ground surface around the machine.

10. The machine of claim 9, wherein the electronic controller is further configured to compile a surface contour for an area extending below and around the machine based on the ground surface and the compacted ground surface information provided to the electronic controller by the plurality of ground sensors.

11. The machine of claim 8, wherein at least one of the plurality of ground sensors is a three-dimensional sensor.

12. The machine of claim 11, wherein the at least one of the plurality of ground sensors is one of a LiDAR (light detection and ranging) sensor, and a stereographic camera.

13. The machine of claim 8, wherein after a sunk condition indication or a ground condition alert is provided, the electronic controller is further configured to adjust a control parameter of the machine.

14. The machine of claim 13, wherein adjusting a control parameter of the machine in the presence of the sunk condition indication or the ground condition alert includes at least one of:
commanding a downshift of the machine;
reducing a speed of the machine,
discontinuing operation of the work implement,
reversing the machine, and
limiting a turning radius of the machine.

15. A method for operating an autonomous machine, comprising:
operating the machine to autonomously traverse an area;
operating one or more sensors associated with the machine to acquire data indicative of a contour of a surface located below a frame of the machine;
providing the acquired data to a controller;
using the controller to create a presumed ground surface based on the acquired data;
using the controller to establish a height difference between the presumed ground surface and the frame of the machine;
monitoring the height difference continuously while the machine traverses the area; and
providing a sunk condition indication in the controller when the height difference is determined to reduce below a threshold value.

16. The method of claim 15, further comprising using a plurality of ground sensors to acquire data indicative of the contour or surfaces located below and around the machine, wherein the electronic controller is further configured to create a presumed ground surface extending below and around the machine.

17. The method of claim 15, wherein at least one of the one or more sensors is a three-dimensional sensor.

18. The method of claim 17, wherein the at least one of the one or more sensors is one of a LiDAR (light detection and ranging) sensor, and a stereographic camera.

19. The method of claim 15, further comprising using the controller to adjust a control parameter of the machine when the sunk condition indication is provided.

20. The method of claim 19, wherein adjusting a control parameter of the machine in the presence of the sunk condition indication includes at least one of:
commanding a downshift of the machine;
reducing a speed of the machine, and
limiting a turning radius of the machine.
